(19) United States
(12) Patent Application Publication
(10) Pub. No.: US 2026/0040331 A1
(43) Pub. Date: Feb. 5, 2026

(54) COMMUNICATION APPARATUS AND COMMUNICATION METHOD FOR SIDELINK CO-CHANNEL COEXISTENCE RESOURCE SELECTION INFORMATION SHARING

(71) Applicant: Panasonic Intellectual Property Corporation of America, Torrance, CA (US)

(72) Inventors: Yang KANG, Singapore (SG); Hidetoshi SUZUKI, Kanagawa (JP); Ayako HORIUCHI, Kanagawa (JP); Hong Cheng Michael SIM, Singapore (SG); Xuan Tuong TRAN, Singapore (SG)

(21) Appl. No.: 19/101,516

(22) PCT Filed: May 29, 2023
(86) PCT No.: PCT/SG2023/050378

§ 371 Date: Feb. 5, 2025

(30) Foreign Application Priority Data
Aug. 12, 2022 (SG) 10202250727B

(51) Int. Cl. H04W 72/25; H04B 17/318; H04W 72/40

(52) U.S. Cl. CPC H04W 72/25; H04B 17/328; H04W 72/40

(57) ABSTRACT

The present disclosure provides a communication apparatus and a communication method for sidelink co-channel coexistence resource selection information sharing, the communication apparatus comprising: a first module, which, in operation, is configured to select a list of first resources from a first plurality of candidate resources based on information relating to one or more resources of a second plurality of candidate resources received from a second module: and a transceiver, which, in operation, transmits to and/or receive from another communication apparatus a signal in one of the list of first resources.

### TECHNICAL FIELD

The following disclosure relates to a communication apparatus and a communication method for resource selection, and more particularly for resource sharing in the context of sidelink co-channel consistence.

### BACKGROUND

The objective of co-channel coexistence for long-term evolution (LTE) sidelink (SL) and new radio (NR) sidelink has been specified, namely, to study and specify, if necessary, mechanism(s) for co-channel coexistence for LTE sidelink and NR sidelink including performance, necessity, feasibility, and potential specification impact if any [RAN1, RAN2, RAN4] and to reuse the in-device coexistence framework defined in Release 16 as much as possible.

However, for LTE SL and NR SL, the LTE SL module and NR SL module separately perform resource selections at their own physical layers (i.e., sensing) and at their own media access control (MAC) layers (i.e., resource reservation). Currently, there is no solution how the resource selection information (e.g., sensing information and/or resource reservation information) is shared and utilized in the context of co-channel coexistence of both LTE SL and NR SL.

There is thus a need for a communication apparatus and a communication method for sidelink co-channel coexistence resource selection information sharing to solve the above-mentioned issues. Furthermore, other desirable features and characteristics will become apparent from the subsequent detailed description and the appended claims, taken in conjunction with the accompanying drawings and this background of the disclosure.

### SUMMARY

Non-limiting and exemplary embodiments facilitate providing communication apparatuses and communication methods for multi-link traffic indication map.

In a first aspect, the present disclosure provides a first communication apparatus, comprising: a first module, which, in operation, is configured to select a list of first resources from a first plurality of candidate resources based on information relating to one or more resources of a second plurality of candidate resources received from a second module; and a transceiver, which, in operation, transmits to and/or receive from another communication apparatus a signal in one of the list of first resources

In a second aspect, the present disclosure provides a second communication apparatus, comprising: a second module, which, in operation, is configured to select a list of second resources from a second plurality of candidate resources; and a transceiver, which, in operation, transmits a signal comprising information relating to the list of second resources to a first communication apparatus for use to select a list of first resources from a first plurality of candidate resources.

In a third aspect, the present disclosure provides a third communication apparatus, comprising: a transceiver, which, in operation, receives information relating to one or more resources from a first communication apparatus; and a third module, which, in operation, is configured to select a list of third resources from a third plurality of candidate resources based on the information relating to the one or more resources, wherein the third communication apparatus is configured to transmit and/or receive a signal in one of the list of resources through the transceiver.

In a fourth aspect, the present disclosure provides a communication method implemented by a first communication apparatus, comprising: selecting, by a first module of the first communication apparatus, a list of first resources from a first plurality of candidate resources based on information relating to one or more resources of a second plurality of candidate resources received from a second module, and transmitting to and/or receiving from another communication apparatus a signal in one of the list of first resources.

In a fifth aspect, the present disclosure provides a communication method implemented by a second communication apparatus, comprising: selecting a list of second resources from a second plurality of candidate resources; and transmits a signal comprising information relating to the list of second resources to a first communication apparatus for use to select a list of first resources from a first plurality of candidate resources.

In a sixth aspect, the present disclosure provides a communication method implemented by a third communication apparatus, comprising: receiving information relating to one or more resources from a first communication apparatus; and selecting, by a third module of the third communication apparatus, a list of third resources from a third plurality of candidate resources based on the information relating to the one or more resources from the first communication apparatus, wherein the third communication apparatus is configured to transmit and/or receive a signal in one of the list of third resources.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to illustrate various embodiments and to explain various principles and advantages in accordance with present embodiments.

FIG. 1 shows an exemplary 3GPP NG-RAN architecture to which exemplary embodiments of the present disclosure may be applied.

FIG. 2 depicts a schematic drawing which shows functional split between NG-RAN and 5GC to which exemplary embodiments of the present disclosure may be applied.

FIG. 3 depicts a sequence diagram for radio resource control (RRC) connection setup/reconfiguration procedures to which exemplary embodiments of the present disclosure may be applied.

FIG. 4 depicts a schematic drawing showing usage scenarios of Enhanced mobile broadband (eMBB), Massive Machine Type Communications (mMTC) and Ultra Reliable and Low Latency Communications (URLLC) to which exemplary embodiments of the present disclosure may be applied.

FIG. 5 shows a block diagram showing an exemplary 5G system architecture for Vehicle-to-everything (V2X) communication in a non-roaming scenario.

FIG. 6 depicts a flowchart illustrating Release 16 new radio (NR) sidelink (SL) sensing process carried out by a NR SL module at physical layer.

FIG. 7 depicts a flowchart illustrating Release 15 long-term evolution (LTE) sidelink (SL) sensing process carried out by an LTE SL module at physical layer.

FIG. 8 shows a schematic example of communication apparatus in accordance with various embodiments.

FIG. 9 shows a flowchart illustrating a communication method implemented by a first communication apparatus according to various embodiments of the present disclosure.

FIG. 10 shows a flowchart illustrating a communication method implemented by a second communication apparatus according to various embodiments of the present disclosure.

FIG. 11 shows a flowchart illustrating a communication method implemented by a third communication apparatus according to various embodiments of the present disclosure.

FIG. 12 depicts a block diagram illustrating a first exemplary mapping of a NR resource pool and an LTE resource pool according to the present disclosure.

FIG. 13A depicts a block diagram illustrating a second exemplary mapping of a NR resource pool and an LTE resource pool according to the present disclosure.

FIG. 13B depicts a block diagram illustrating a third exemplary mapping of a NR resource pool and an LTE resource pool according to present disclosure.

FIG. 14 shows a flowchart illustrating a resource selection process carried out by a NR SL module according to a first embodiment of the present disclosure.

FIG. 15 shows a flowchart illustrating a resource selection process carried by a NR SL module according to a second embodiment of the present disclosure.

FIG. 16 shows a flowchart illustrating a resource selection process carried by a NR SL module at media access control (MAC) layer according to a third embodiment of the present disclosure.

FIG. 17 shows a flowchart illustrating a resource selection process carried by a NR SL module of a SL device at MAC layer after receiving preferred LTE reported resources indicated by other SL devices according to a first example of a fourth embodiment of the present disclosure.

FIG. 18 shows a flowchart illustrating a resource selection process carried by a NR SL module of a SL device at MAC layer after receiving preferred LTE reported resources indicated by other SL devices according to a second example of the fourth embodiment of the present disclosure.

Skilled artisans will appreciate that elements in the figures are illustrated for simplicity and clarity and have not necessarily been depicted to scale. For example, the dimensions of some of the elements in the illustrations, block diagrams or flowcharts may be exaggerated in respect to other elements to help an accurate understanding of the present embodiments.

### DETAILED DESCRIPTION

Some embodiments of the present disclosure will be described, by way of example only, with reference to the drawings. Like reference numerals and characters in the drawings refer to like elements or equivalents.

3GPP has been working at the next release for the 5^{th} generation cellular technology, simply called 5G, including the development of a new radio access technology (NR) operating in frequencies ranging up to 100 GHz. The first version of the 5G standard was completed at the end of 2017, which allows proceeding to 5G NR standard-compliant trials and commercial deployments of smartphones.

The second version of the 5G standard was completed in June 2020, which further expand the reach of 5G to new services, spectrum and deployment such as unlicensed spectrum (NR-U), non-public network (NPN), time sensitive networking (TSN) and cellular-V2X.

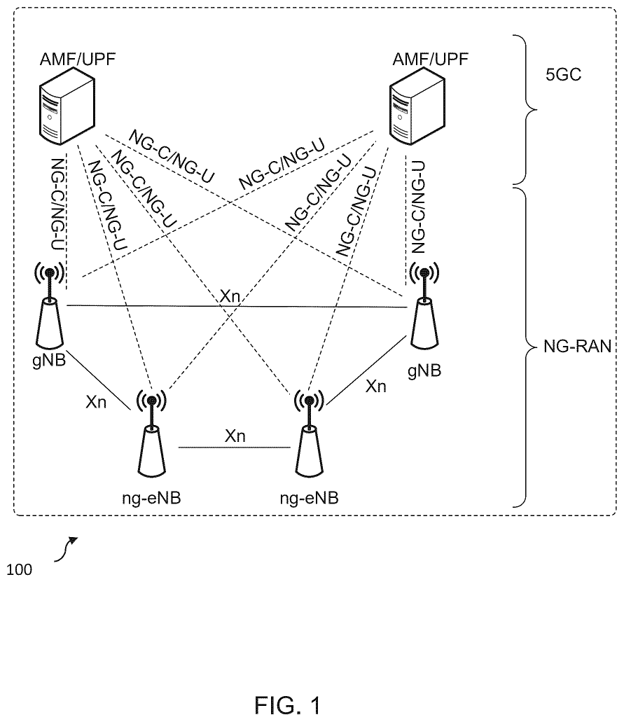

Among other things, the overall system architecture assumes an NG-RAN (Next Generation-Radio Access Network) that comprises gNBs, providing the NG-radio access user plane (SDAP/PDCP/RLC/MAC/PHY) and control plane (RRC) protocol terminations towards the UE. The gNBs are interconnected with each other by means of the Xn interface. The gNBs are also connected by means of the Next Generation (NG) interface to the NGC (Next Generation Core), more specifically to the AMF (Access and Mobility Management Function) (e.g., a particular core entity performing the AMF) by means of the NG-C interface and to the UPF (User Plane Function) (e.g., a particular core entity performing the UPF) by means of the NG-U interface. The NG-RAN architecture is illustrated in FIG. 1 (see e.g., 3GPP TS 38.300 v16.3.0).

The user plane protocol stack for NR (see e.g., 3GPP TS 38.300, section 4.4.1) comprises the PDCP (Packet Data Convergence Protocol, see section 6.4 of TS 38.300), RLC (Radio Link Control, see section 6.3 of TS 38.300) and MAC (Medium Access Control, see section 6.2 of TS 38.300) sublayers, which are terminated in the gNB on the network side. Additionally, a new access stratum (AS) sublayer (SDAP, Service Data Adaptation Protocol) is introduced above PDCP (see e.g., sub-clause 6.5 of 3GPP TS 38.300). A control plane protocol stack is also defined for NR (see for instance TS 38.300, section 4.4.2). An overview of the Layer 2 functions is given in sub-clause 6 of TS 38.300. The functions of the PDCP, RLC and MAC sublayers are listed respectively in sections 6.4, 6.3, and 6.2 of TS 38.300. The functions of the RRC layer are listed in sub-clause 7 of TS 38.300.

For instance, the Medium-Access-Control layer handles logical-channel multiplexing, and scheduling and scheduling-related functions, including handling of different numerologies.

The physical layer (PHY) is for example responsible for coding, PHY hybrid automatic repeat request (HARQ) processing, modulation, multi-antenna processing, and mapping of the signal to the appropriate physical time-frequency resources. It also handles mapping of transport channels to physical channels. The physical layer provides services to the MAC layer in the form of transport channels. A physical channel corresponds to the set of time-frequency resources used for transmission of a particular transport channel, and each transport channel is mapped to a corresponding physical channel. For instance, the physical channels are PRACH (Physical Random Access Channel), PUSCH (Physical Uplink Shared Channel) and PUCCH (Physical Uplink Control Channel) for uplink, PDSCH (Physical Downlink Shared Channel), PDCCH (Physical Downlink Control Channel) and PBCH (Physical Broadcast Channel) for downlink, and PSSCH (Physical Sidelink Shared Channel), PSCCH (Physical Sidelink Control Channel) and Physical Sidelink Feedback Channel (PSFCH) for sidelink (SL).

SL supports UE-to-UE direct communication using the SL resource allocation modes, physical layer signals/channels, and physical layer procedures. Two new radio (NR) SL resource allocation modes are supported: (a) mode 1, where the NR SL resource allocation is provided by the network; and (b) mode 2, where UE decides NR SL transmission resource in the resource pool(s). Two SL resource allocations modes are applicable to LTE V2X: (a) mode 3, where the LTE SL resource allocation is scheduled by eNB primarily for transmission of periodically-occurring messages; and (b) mode 4, where the UE decides autonomously the LTE SL transmission resource in the resource pool(s).

PSCCH indicates resource and other transmission parameters used by a UE for PSSCH. PSCCH transmission is associated with a demodulation reference signal (DM-RS). PSSCH transmits the transport blocks (TBs) of data themselves, and control information for HARQ procedure and channel state information (CSI) feedback triggers, etc. At least 6 Orthogonal Frequency Division Multiplex (OFDM) symbols within a slot are used for PSSCH transmission. PSSCH transmission is associated with a DM-RS and may be associated with a phase-tracking reference signal (PT-RS).

PSFCH carries HARQ feedback over the SL from a UE which is an intended recipient of a PSSCH transmission to the UE which performed the transmission. PSFCH sequence is transmitted in one PRB repeated over two OFDM symbols near the end of the SL resource in a slot.

The SL synchronization signal consists of SL primary and SL secondary synchronization signals (S-PSS, S-SSS), each occupying 2 symbols and 127 subcarriers. Physical Sidelink Broadcast Channel (PSBCH) occupies 9 and 5 symbols for normal and extended cyclic prefix cases respectively, including the associated demodulation reference signal (DM-RS).

Regarding physical layer procedure for HARQ feedback for sidelink, SL HARQ feedback uses PSFCH and can be operated in one of two options. In one option, which can be configured for unicast and groupcast, PSFCH transmits either ACK or NACK using a resource dedicated to a single PSFCH transmitting UE. In another option, which can be configured for groupcast, PSFCH transmits NACK, or no PSFCH signal is transmitted, on a resource that can be shared by multiple PSFCH transmitting UEs.

In SL resource allocation mode 1, a UE which received PSFCH can report SL HARQ feedback to gNB via PUCCH or PUSCH.

Regarding physical layer procedure for power control for sidelink, for in-coverage operation, the power spectral density of the SL transmissions can be adjusted based on the pathloss from the gNB; whereas for unicast, the power spectral density of some SL transmissions can be adjusted based on the pathloss between the two communicating Ues.

Regarding physical layer procedure for CSI report, for unicast, channel state information reference signal (CSI-RS) is supported for CSI measurement and reporting in sidelink. A CSI report is carried in a SL MAC CE.

For measurement on the sidelink, the following UE measurement quantities are supported:
PSBCH reference signal received power (PSBCH RSRP);
PSSCH reference signal received power (PSSCH-RSRP);
PSCCH reference signal received power (PSCCH-RSRP);
Sidelink received signal strength indicator (SL RSSI);
Sidelink channel occupancy ratio (SL CR);
Sidelink channel busy ratio (SL CBR).

Use cases/deployment scenarios for NR could include enhanced mobile broadband (eMBB), ultra-reliable low-latency communications (URLLC), massive machine type communication (mMTC), which have diverse requirements in terms of data rates, latency, and coverage. For example, eMBB is expected to support peak data rates (20 Gbps for downlink and 10 Gbps for uplink) and user-experienced data rates in the order of three times what is offered by IMT-Advanced. On the other hand, in case of URLLC, the tighter requirements are put on ultra-low latency (0.5 ms for UL and DL each for user plane latency) and high reliability (1-10-5 within 1 ms). Finally, mMTC may preferably require high connection density (1,000,000 devices/km2 in an urban environment), large coverage in harsh environments, and extremely long-life battery for low cost devices (15 years).

Therefore, the OFDM numerology (e.g., subcarrier spacing, OFDM symbol duration, cyclic prefix (CP) duration, number of symbols per scheduling interval) that is suitable for one use case might not work well for another. For example, low-latency services may preferably require a shorter symbol duration (and thus larger subcarrier spacing) and/or fewer symbols per scheduling interval (also known as transmission time interval (TTI)) than an mMTC service. Furthermore, deployment scenarios with large channel delay spreads may preferably require a longer CP duration than scenarios with short delay spreads. The subcarrier spacing should be optimized accordingly to retain the similar CP overhead. NR may support more than one value of subcarrier spacing. Correspondingly, subcarrier spacing of 15 kHz, 30 kHz, 60 kHz . . . are being considered at the moment. The symbol duration Tu and the subcarrier spacing Δf are directly related through the formula Δf=1/Tu. In a similar manner as in LTE systems, the term “resource element” can be used to denote a minimum resource unit being composed of one subcarrier for the length of one OFDM/SC-FDMA symbol.

In the new radio system 5G-NR for each numerology and carrier a resource grid of subcarriers and OFDM symbols is defined respectively for uplink and downlink. Each element in the resource grid is called a resource element and is identified based on the frequency index in the frequency domain and the symbol position in the time domain (see 3GPP TS 38.211 v16.3.0).

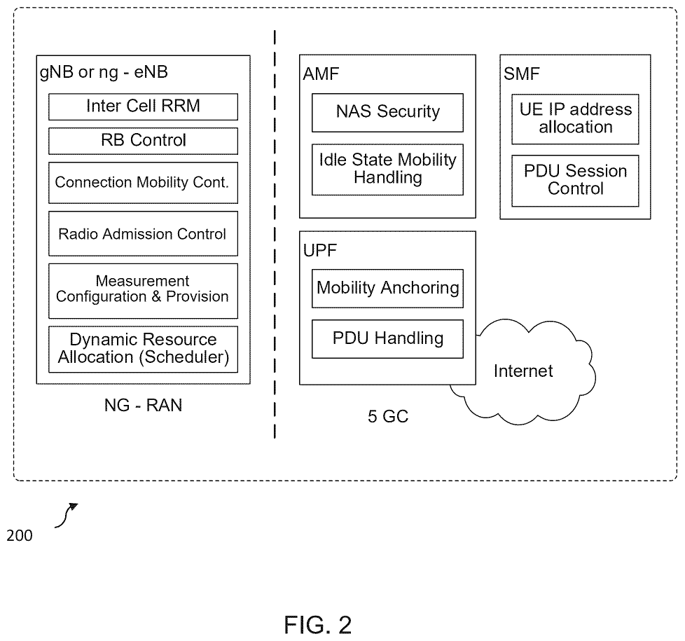

FIG. 2 illustrates functional split between NG-RAN and 5GC to which exemplary embodiments of the present disclosure may be applied. NG-RAN logical node is a gNB or ng-eNB. The 5GC has logical nodes AMF, UPF and SMF.

In particular, the gNB and ng-eNB host the following main functions:
Functions for Radio Resource Management such as Radio Bearer Control, Radio Admission Control, Connection Mobility Control, Dynamic allocation of resources to UEs in both uplink and downlink (scheduling);
IP header compression, encryption and integrity protection of data;
Selection of an AMF at UE attachment when no routing to an AMF can be determined from the information provided by the UE;
Routing of User Plane data towards UPF(s);
Routing of Control Plane information towards AMF;
Connection setup and release;
Scheduling and transmission of paging messages;
Scheduling and transmission of system broadcast information (originated from the AMF or OAM);
Measurement and measurement reporting configuration for mobility and scheduling;
Transport level packet marking in the uplink;
Session Management;
Support of Network Slicing;
QoS Flow management and mapping to data radio bearers;
Support of UEs in RRC_INACTIVE state;
Distribution function for NAS messages;
Radio access network sharing;
Dual Connectivity;
Tight interworking between NR and E-UTRA.

The Access and Mobility Management Function (AMF) hosts the following main functions:
Non-Access Stratum, NAS, signaling termination;
NAS signaling security;
Access Stratum, AS, Security control;
Inter Core Network, CN, node signaling for mobility between 3GPP access networks;
Idle mode UE Reachability (including control and execution of paging retransmission);
Registration Area management;
Support of intra-system and inter-system mobility;
Access Authentication;
Access Authorization including check of roaming rights;
Mobility management control (subscription and policies);
Support of Network Slicing;
Session Management Function, SMF, selection.

Furthermore, the User Plane Function, UPF, hosts the following main functions:
Anchor point for Intra-/Inter-RAT mobility (when applicable);
External PDU session point of interconnect to Data Network;
Packet routing & forwarding;
Packet inspection and User plane part of Policy rule enforcement;
Traffic usage reporting;
Uplink classifier to support routing traffic flows to a data network;
Branching point to support multi-homed PDU session;
QoS handling for user plane, e.g., packet filtering, gating, UL/DL rate enforcement;
Uplink Traffic verification (SDF to QoS flow mapping);
Downlink packet buffering and downlink data notification triggering.

Finally, the Session Management function, SMF, hosts the following main functions:
Session Management;
UE IP address allocation and management;
Selection and control of UP function;
Configures traffic steering at User Plane Function, UPF, to route traffic to proper destination;
Control part of policy enforcement and QoS;
Downlink Data Notification.

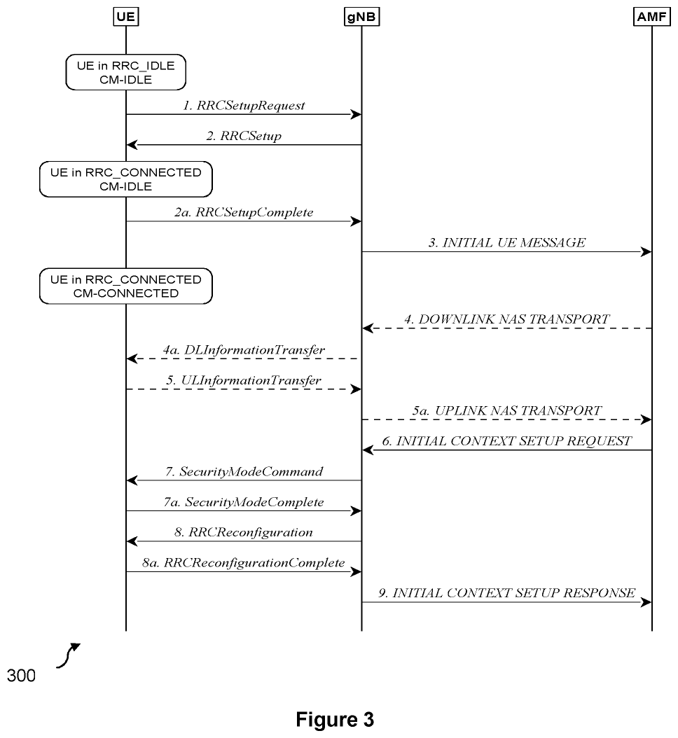

FIG. 3 illustrates some interactions between a UE, gNB, and AMF (an 5GC entity) in the context of a transition of the UE from RRC_IDLE to RRC_CONNECTED for the NAS part (see TS 38.300 v16.3.0). The transition steps are as follows:
1. The UE requests to setup a new connection from RRC_IDLE.
2/2a. The gNB completes the RRC setup procedure.
NOTE: The scenario where the gNB rejects the request is described below.
3. The first NAS message from the UE, piggybacked in RRCSetupComplete, is sent to AMF.
4/4a/5/5a. Additional NAS messages may be exchanged between UE and AMF, see TS 23.502.
6. The AMF prepares the UE context data (including PDU session context, the Security Key, UE Radio Capability and UE Security Capabilities, etc.) and sends it to the gNB.
7/7a. The gNB activates the AS security with the UE.
8/8a. The gNB performs the reconfiguration to setup SRB2 and DRBs.
9. The gNB informs the AMF that the setup procedure is completed.

RRC is a higher layer signaling (protocol) used for UE and gNB configuration. In particular, this transition involves that the AMF prepares the UE context data (including e.g., PDU session context, the Security Key, UE Radio Capability and UE Security Capabilities, etc.) and sends it to the gNB with the INITIAL CONTEXT SETUP REQUEST. Then, the gNB activates the AS security with the UE, which is performed by the gNB transmitting to the UE a SecurityModeCommand message and by the UE responding to the gNB with the SecurityModeComplete message. Afterwards, the gNB performs the reconfiguration to setup the Signaling Radio Bearer 2, SRB2, and Data Radio Bearer(s), DRB(s) by means of transmitting to the UE the RRCReconfiguration message and, in response, receiving by the gNB the RRCReconfigurationComplete from the UE. For a signaling-only connection, the steps relating to the RRCReconfiguration are skipped since SRB2 and DRBs are not setup. Finally, the gNB informs the AMF that the setup procedure is completed with the INITIAL CONTEXT SETUP RESPONSE.

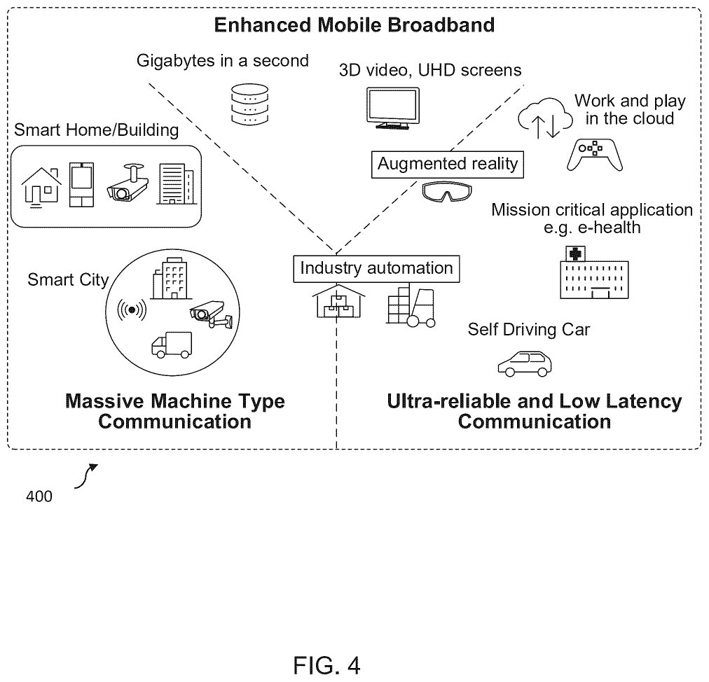

FIG. 4 illustrates some of the use cases for 5G NR. In 3rd generation partnership project new radio (3GPP NR), three use cases are being considered that have been envisaged to support a wide variety of services and applications by IMT-2020. The specification for the phase 1 of enhanced mobile-broadband (eMBB) has been concluded. In addition to further extending the eMBB support, the current and future work would involve the standardization for ultra-reliable and low-latency communications (URLLC) and massive machine-type communications. FIG. 4 illustrates some examples of envisioned usage scenarios for IMT for 2020 and beyond (see e.g., ITU-R M.2083 FIG. 2).

The URLLC use case has stringent requirements for capabilities such as throughput, latency and availability and has been envisioned as one of the enablers for future vertical applications such as wireless control of industrial manufacturing or production processes, remote medical surgery, distribution automation in a smart grid, transportation safety, etc. Ultra-reliability for URLLC is to be supported by identifying the techniques to meet the requirements set by TR 38.913. For NR URLLC in Release 15, key requirements include a target user plane latency of 0.5 ms for UL (uplink) and 0.5 ms for DL (downlink). The general URLLC requirement for one transmission of a packet is a BLER (block error rate) of 1E-5 for a packet size of 32 bytes with a user plane latency of 1 ms.

From the physical layer perspective, reliability can be improved in a number of possible ways. The current scope for improving the reliability involves defining separate CQI tables for URLLC, more compact DCI formats, repetition of PDCCH, etc. However, the scope may widen for achieving ultra-reliability as the NR becomes more stable and developed (for NR URLLC key requirements). Particular use cases of NR URLLC in Rel. 15 include Augmented Reality/Virtual Reality (AR/VR), e-health, e-safety, and mission-critical applications.

Moreover, technology enhancements targeted by NR URLLC aim at latency improvement and reliability improvement. Technology enhancements for latency improvement include configurable numerology, non slot-based scheduling with flexible mapping, grant free (configured grant) uplink, slot-level repetition for data channels, and downlink pre-emption. Pre-emption means that a transmission for which resources have already been allocated is stopped, and the already allocated resources are used for another transmission that has been requested later, but has lower latency/higher priority requirements. Accordingly, the already granted transmission is pre-empted by a later transmission. Pre-emption is applicable independent of the particular service type. For example, a transmission for a service-type A (URLLC) may be pre-empted by a transmission for a service type B (such as eMBB). Technology enhancements with respect to reliability improvement include dedicated CQI/MCS tables for the target BLER of 1E-5.

The use case of mMTC (massive machine type communication) is characterized by a very large number of connected devices typically transmitting a relatively low volume of non-delay sensitive data. Devices are required to be low cost and to have a very long battery life. From NR perspective, utilizing very narrow bandwidth parts is one possible solution to have power saving from UE perspective and enable long battery life.

As mentioned above, it is expected that the scope of reliability in NR becomes wider. One key requirement to all the cases, and especially necessary for URLLC and mMTC, is high reliability or ultra-reliability. Several mechanisms can be considered to improve the reliability from radio perspective and network perspective. In general, there are a few key potential areas that can help improve the reliability. Among these areas are compact control channel information, data/control channel repetition, and diversity with respect to frequency, time and/or the spatial domain. These areas are applicable to reliability in general, regardless of particular communication scenarios.

For NR URLLC, further use cases with tighter requirements have been identified such as factory automation, transport industry and electrical power distribution, including factory automation, transport industry, and electrical power distribution. The tighter requirements are higher reliability (up to 10-6 level), higher availability, packet sizes of up to 256 bytes, time synchronization down to the order of a few μs where the value can be one or a few us depending on frequency range and short latency in the order of 0.5 to 1 ms in particular a target user plane latency of 0.5 ms, depending on the use cases.

Moreover, for NR URLLC, several technology enhancements from the physical layer perspective have been identified. Among these are PDCCH (Physical Downlink Control Channel) enhancements related to compact DCI, PDCCH repetition, increased PDCCH monitoring. Moreover, UCI (Uplink Control Information) enhancements are related to enhanced HARQ (Hybrid Automatic Repeat Request) and CSI feedback enhancements. Also PUSCH enhancements related to mini-slot level hopping and retransmission/repetition enhancements have been identified. The term “mini-slot” refers to a Transmission Time Interval (TTI) including a smaller number of symbols than a slot (a slot comprising fourteen symbols).

The 5G QoS (Quality of Service) model is based on QoS flows and supports both QoS flows that require guaranteed flow bit rate (GBR QoS flows) and QoS flows that do not require guaranteed flow bit rate (non-GBR QoS Flows). At NAS level, the QoS flow is thus the finest granularity of QoS differentiation in a PDU session. A QoS flow is identified within a PDU session by a QoS flow ID (QFI) carried in an encapsulation header over NG-U interface.

For each UE, 5GC establishes one or more PDU Sessions. For each UE, the NG-RAN establishes at least one Data Radio Bearers (DRB) together with the PDU Session, and additional DRB(s) for QoS flow(s) of that PDU session can be subsequently configured (it is up to NG-RAN when to do so), e.g., as shown above with reference to FIG. 3. The NG-RAN maps packets belonging to different PDU sessions to different DRBs. NAS level packet filters in the UE and in the 5GC associate UL and DL packets with QoS Flows, whereas AS-level mapping rules in the UE and in the NG-RAN associate UL and DL QoS Flows with DRBs.

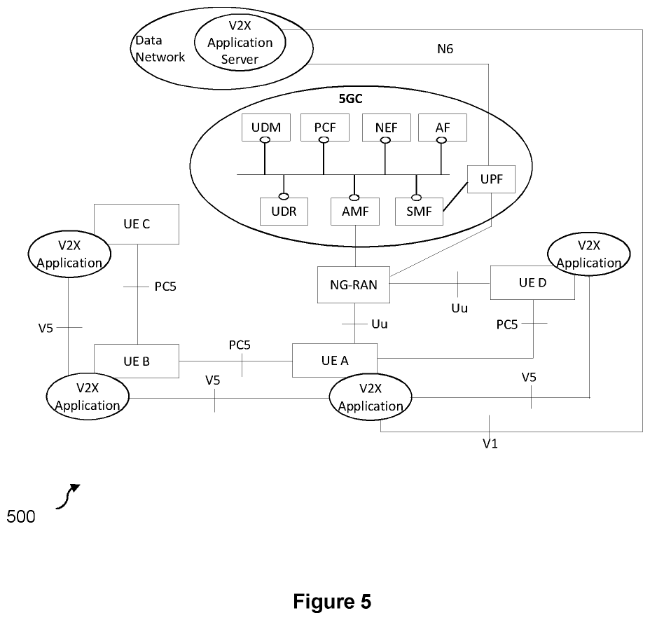

FIG. 5 illustrates a 5G NR non-roaming reference architecture (see TS 23.287 v16.4.0, section 4.2.1.1). An Application Function (AF), e.g., an external application server hosting 5G services, exemplarily described in FIG. 4, interacts with the 3GPP Core Network in order to provide services, for example to support application influence on traffic routing, accessing Network Exposure Function (NEF) or interacting with the Policy framework for policy control (see Policy Control Function, PCF), e.g., QoS control. Based on operator deployment, Application Functions considered to be trusted by the operator can be allowed to interact directly with relevant Network Functions. Application Functions not allowed by the operator to access directly the Network Functions use the external exposure framework via the NEF to interact with relevant Network Functions.

FIG. 5 shows further functional units of the 5G architecture for V2X communication, namely, Unified Data Management (UDM), Policy Control Function (PCF), Network Exposure Function (NEF), Application Function (AF), Unified Data Repository (UDR), Access and Mobility Management Function (AMF), Session Management Function (SMF), and User Plane Function (UPF) in the 5GC, as well as with V2X Application Server (V2AS) and Data Network (DN), e.g., operator services, Internet access or 3rd party services. All or a part of the core network functions and the application services may be deployed and running on cloud computing environments.

In the present disclosure, thus, an application server (for example, AF of the 5G architecture), is provided that comprises a transmitter, which, in operation, transmits a request containing a QoS requirement for at least one of URLLC, eMBB and mMTC services to at least one of functions (for example NEF, AMF, SMF, PCF, UPF, etc) of the 5GC to establish a PDU session including a radio bearer between a gNodeB and a UE in accordance with the QoS requirement and control circuitry, which, in operation, performs the services using the established PDU session.

The objective to study and specify, if necessary, mechanism(s) for co-channel coexistence for long-term evolution (LTE) sidelink (SL) and new radio (NR) sidelink (SL) including performance, necessity, feasibility, and potential specification impact if any [RAN1, RAN2, RAN4] and to reuse the in-device coexistence framework defined in Release 16 as much as possible has been specified for upcoming studies in 3GPP Release 18 Sidelink Evolution as described in WID RP-213634.

Sidelink (SL) devices could be categorized at lease for following types:
Type A: Rel-18 devices that contain both LTE SL and NR SL modules;
Type B: Rel-18 devices that contain only NR SL modules;
Type C: Rel-14/Rel-15 devices that contain only LTE SL modules;
Type D: Rel-16/17 devices that contain only NR SL modules; and
Type E: Rel-16 devices that contain both LTE SL and NR SL modules based on in-device coexistence framework.

For type A devices, it may indicate their own reservation with both LTE and NR SCIs (at least for type C devices as audiences). In particular, in RAN1 #109-e meeting, it has been discussed that for type A devices that have both LTE SL module and NR SL module, the LTE sensing and resource reservation information can be shared to NR SL module. According to FL Proposal 2-4 (II), for studying the feasibility of dynamic resource sharing as a possible solution for co-channel coexistence, and for device type A (i.e., Release 18 devices that contain both LTE SL and NR SL modules), the NR SL module uses the sensing and resource reservation information shared by the LTE SL module. There are also FFS details on how the NR SL module uses this information, how the LTE SL module shares the information to the NR SL module, exact information shared, timeline etc, whether/how to define other method(s) for device type A to be aware of resources being occupied by LTE SL, and whether/how device type B (i.e., Release 18 devices that contain only NR SL modules) should be supported.

However, as mentioned earlier, for LTE SL and NR SL, the LTE SL module and NR SL module separately perform resource selections at their own physical layers (i.e., sensing) and at their own media access control (MAC) layers (i.e., resource reservation). Currently, there is no solution how the resource selection information (e.g., sensing information and/or resource reservation information) is shared and utilized in the context of co-channel coexistence of both LTE SL and NR SL. There is thus a need for a communication apparatus and a communication method for sidelink co-channel coexistence resource selection information sharing to solve the above-mentioned issues.

According to the present disclosure, the term “LTE SL module” may be used interchangeably with “LTE module”. Likewise, the term “NR SL module” may be used interchangeably with “NR module”.

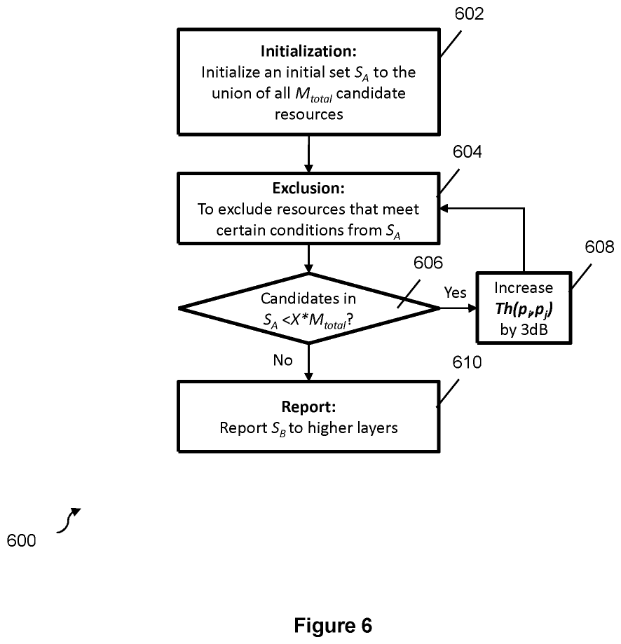

FIG. 6 depicts a flowchart 600 illustrating Release 16 NR SL sensing process carried out by a NR SL module at physical layer. In step 602, an initialization step is carried out where an initial set of candidate resources S_{A} is initialized to the union of all candidate resources Mₜₒₜₐₗ. In step 604, an exclusion step is carried out where resources that meet certain conditions are excluded from the initial set S_{A}. In one example, each of the candidate resources in the initial set S_{A} has a level related to reference signal received power (RSRP), and such level related to RSRP will be compared against a threshold level Th(pᵢ, pⱼ). The candidate resource will be excluded from the initial set S_{A} if its level related RSRP is higher than the threshold level Th(pᵢ, pⱼ).

In step 606, a determination step is carried out. It is determined in step 606, if the number of candidate resources remaining in the initial set S_{A} is smaller than X*Mₜₒₜₐₗ, where X is a pre-configured threshold ratio within the range of 0 and 1, which is a ratio of a number of candidate resources remaining in the initial set S_{A} after the exclusion step in step 604 to total number of candidate resources between 0 to 1, is carried out. If the number of candidate resources remaining in the initial set S_{A} is smaller than X*Mₜₒₜₐₗ, then step 608 is carried out; otherwise step 610 is carried out. In step 608, the threshold level Th(pᵢ, pⱼ) is increased by 3 dB such that the number of candidate resources remained in the set from the initial set S_{A} may increase correspondingly. The exclusion step, determination step and the step with the threshold level Th(pᵢ, pⱼ) increased by 3 dB in steps 604, 606, 608 are repeated until it is determined that the number of candidate resources remaining in the initial set S_{A} is no longer smaller than X*Mₜₒₜₐₗ. In step 610, the resource candidate remaining in the initial set S_{A} are moved to set of candidate resources S_{B} and the set S_{B} is reported to higher layers such as a MAC layer.

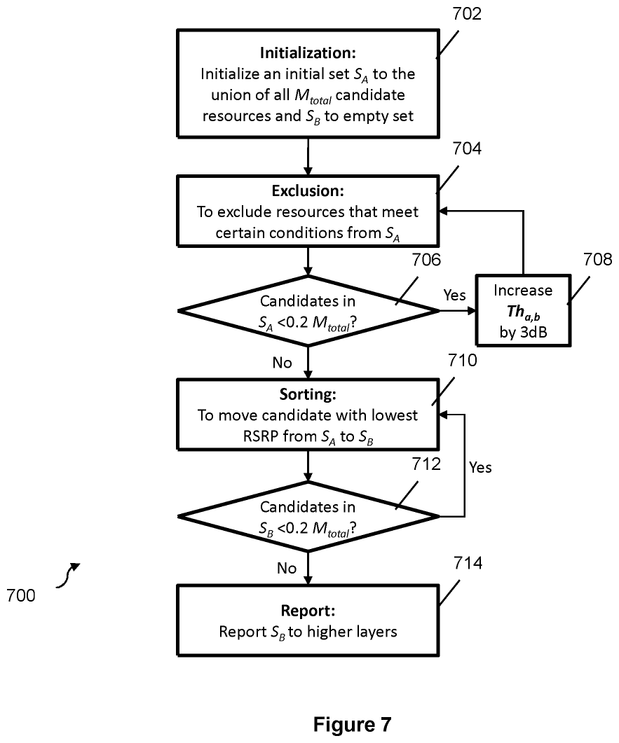

FIG. 7 depicts a flowchart 700 illustrating Release 15 LTE SL sensing process carried out by an LTE SL module at physical layer. In step 702, an initialization step is carried out where an initial set of candidate resources S_{A} is initialized to the union of all candidate resources Mₜₒₜₐₗ and another set S_{B} is initialized to an empty set. In step 704, an exclusion step is carried out where resources that meet certain conditions from the initial set S_{A} are excluded. In one example, each of the candidate resources in the initial set S_{A} has a level related to reference signal received power (RSRP), and such level related to RSRP will be compared against a threshold level Th_{a,b}. The candidate resource will be excluded from the initial set S_{A} if its level related RSRP is higher than the threshold level Th_{a,b}.

In step 706, a step of determining if the number of candidate resources remaining in the initial set S_{A} is smaller than 0.2 Mₜₒₜₐₗ (i.e., the pre-configured threshold ratio of a number of candidate resources remaining in the initial set S_{A} after the exclusion step in step 704 to total number of candidate resources is 0.2) is carried out. If the number of candidate resources remaining in the initial set SAis smaller than 0.2 Mₜₒₜₐₗ, step 708 is carried out; otherwise step 710 is carried out. In step 708, the threshold level Th_{a,b} is increased by 3 dB such that the number of candidate resources remained in the set from the initial set S_{A} may increase correspondingly. The exclusion step, the determination step and the step with the threshold level Th_{a,b} increased by 3 dB in steps 704, 706, 708 are repeated until it is determined that the number of candidate resources remaining in the initial set S_{A} is no longer smaller than X*Mₜₒₜₐₗ.

In step 710, a sorting (moving) step is carried out where the candidate resource with the lowest level relating to the RSRP in the initial set S_{A} is moved to set S_{B}. In step 712, a step of determining if the number of candidate resources remaining in the initial set S_{A} is smaller than 0.2 Mₜₒₜₐₗ (i.e., the pre-configured threshold ratio of a number of candidate resources remaining in the set S_{B} to total number of candidate resources is 0.2) is carried out. If the number of candidate resources remaining in the set S_{B} is smaller than 0.2 Mₜₒₜₐₗ, step 714 is carried out; the sorting (moving) step 710 is repeated, that is the candidate resource with the lowest level relating to the RSRP among the candidate resources remaining in the initial set S_{A} (that has not been moved to S_{B} will then be moved to set S_{B}. The sorting (moving) step and the determination step in steps 710, 712 are repeated until the number of candidate resources remaining in the initial set S_{A} is greater than 0.2 Mₜₒₜₐₗ. In step 714, the set S_{B} is reported to higher layers such as a MAC layer.

According to the present disclosure, for co-channel coexistence of LTE SL and NR SL where the resource selection at the physical layer and/or the MAC layer (i.e., sensing and/or resource reservation procedures) performed by an LTE SL module(s) and by a NR SL module(s) separately, some signalling (in-device if the LTE SL module(s) and NR SL module(s) are within a same physical device or over-the-air if the LTE SL module(s) and NR SL module(s) are from different devices) can be used to indicate shared physical/MAC layer resource selection information (i.e., sensing/resource reservation information) between the different SL modules. The shared information may include at least some or all of the sensing and resource reservation information measurement results (e.g., RSRP) and reported resources (e.g., S_{A}, S_{B}) of the sensing and resource reservation procedures. For non-shared resource selection information e.g., any information, measurement result, etc. that is not indicated to other SL module), no special handling is needed for neither the LTE SL module (or NR SL module) sharing the shared information nor the counterpart NR SL module (or LTE SL module) to be indicated with or to receive/retrieve the shared information. The counterpart module can then use the shared information it received from another module in its resource selection at the physical layer and/or the MAC layer (i.e., sensing and/or resource reservation procedures).

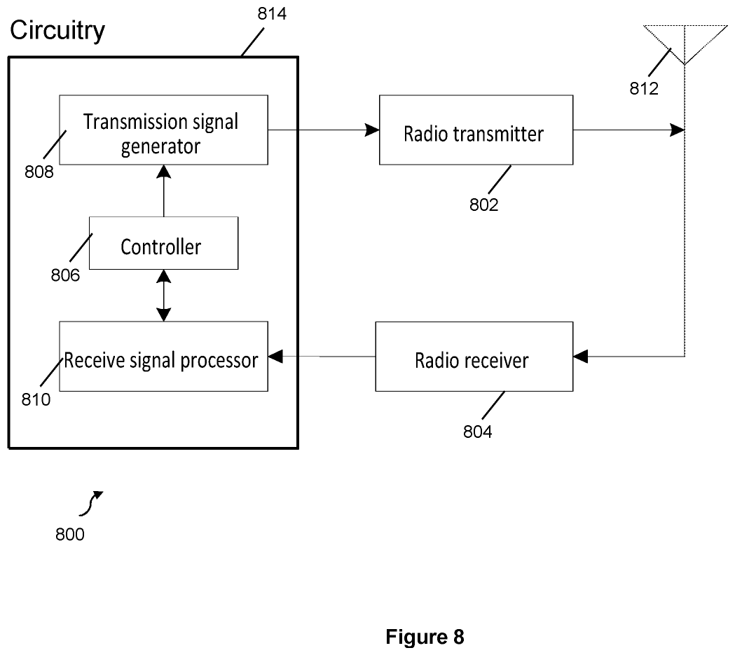

FIG. 8 shows a schematic diagram illustrating an example configuration of a communication apparatus 800 for sidelink co-channel coexistence resource selection information sharing in accordance with various embodiments of the present disclosure. The communication apparatus 800 may be implemented a user equipment (UE) configured for a sidelink signal transmission or reception in accordance with the present disclosure. As shown in FIG. 8, the communication apparatus 800 may include circuitry 814, at least one radio transmitter 802, at least one radio receiver 804, and at least one antenna 812 (for the sake of simplicity, only one antenna is depicted in FIG. 8 for illustration purposes). The circuitry 814 may include at least one controller 806 for use in software and hardware aided execution of tasks that the at least one controller 806 is designed to perform, including control of communications with one or more other communication apparatuses in a multiple input and multiple output (MIMO) wireless network. The circuitry 814 may furthermore include at least one transmission signal generator 808 and at least one receive signal processor 810. The at least one controller 806 may control the at least one transmission signal generator 808 for generating a downlink signal or a sidelink signal to be sent through the at least one radio transmitter 802 and the at least one receive signal processors 810 for processing a downlink signal or a sidelink signal received through the at least one radio receiver 804 from the one or more other communication apparatuses. The at least one transmission signal generator 808 and the at least one receive signal processor 810 may be stand-alone modules of the communication apparatus 800 that communicate with the at least one controller 806 for the above-mentioned functions, as shown in FIG. 8. Alternatively, the at least one transmission signal generator 808 and the at least one receive signal processor 810 may be included in the at least one controller 806. It is appreciable to those skilled in the art that the arrangement of these functional modules is flexible and may vary depending on the practical needs and/or requirements. The data processing, storage and other relevant control apparatus can be provided on an appropriate circuit board and/or in chipsets. In various embodiments, when in operation, the at least one radio transmitter 802, at least one radio receiver 804, and at least one antenna 812 may be controlled by the at least one controller 806.

In various embodiments of the present disclosure, the at least one radio receiver 804 and the at least one radio transmitter 802 may be integrated into at least one radio transceiver configured to perform functions of both the at least one radio receiver 804 and the at least one radio transmitter 802.

The communication apparatus 800, when in operation, provides functions required for sidelink co-channel coexistence resource selection information sharing. For example, the communication apparatus 800 may be a first UE and the at least one controller 806 of the circuitry 814 comprises a first module (not shown, e.g., NR SL module), which, in operation, is configured to select a list (or set) of first resources from first plurality of candidate resources based on information relating to one or more resources of a second plurality of candidate resources received from a second module (not shown, e.g., LTE SL module comprised on the at least one controller 806 of the first UE or on a second/another UE). The circuitry 814 (or the at least one transmission signal generator 808 of the circuitry 814) may be configured to generate a signal and the at least one radio transmitter 802 may then transmit the signal to another communication apparatus in one of the list (or set) of first resources. Alternatively or additionally, the at least one radio receiver 804 may receive a signal from another communication apparatus in one of the list (or set) of first resources and the circuitry 814 (or the at least one receive signal processor 810 of the circuitry 814) may then process the signal.

In one embodiment, the at least one controller 806 of the circuitry 814 may further comprise the second module (not shown), which, in operation, is configured to select a list of second resources from the second plurality of candidate resources. The first module may be further configured to retrieve the information relating to the list of second resources of the second plurality of candidate resources from the second module to select the list of first resources from the first plurality of candidate resources.

In an alternative embodiment, the second module is comprised on a second/another UE and the at least one radio transmitter 802 may receive another signal from the second module from the second/other UE comprising the information relating to one or more resources of the second plurality of candidate resources. The first module may then select the list of first resources from the first plurality of candidate resources based on the information of the other signal received from the second/other UE.

In an embodiment, the first module is configured to determine whether a level relating to a RSRP of each resource of the first plurality of candidate resources and select the list of first resources in response to determining to a level relating to a RSRP of each first resource of the list of first resources is lower than a first threshold level relating to the RSRP (e.g., Th(pᵢ, pⱼ) for NR SL module). Alternatively or additionally, the second module is configured to determine whether a level relating to a RSRP of each resource of the second plurality of candidate resources exclude one or more resources from the second plurality of candidate resources in response to determining a level relating to the RSRP of each resource of the one or more resources of the second plurality of candidate resources is lower than a second threshold level relating to the RSRP (e.g., Th_{a,b} for LTE SL module) and the first module is further configured to exclude one or more resources from the first plurality of candidate resources based on information relating to the one or more resources excluded from the second plurality of candidate resources retrieved by a physical layer of the first module and select the list of first resources from the candidate resources remaining in the first plurality of candidate resources after the exclusion of the one or more resources from the first plurality of candidate resources.

Additionally, the first module may be further configured to determine whether a ratio of a number of the candidate resources remaining in the first plurality of candidate resources to a number of the first plurality of candidate resources is less than a pre-configured threshold ratio and increase/decrease the first threshold level relating to the RSRP in response to determining the ratio of the number of the candidate resources remaining in the first plurality of candidate resources after the exclusion of the one or more resources from the first plurality of candidate resources to the number of the first plurality of candidate resources is less than the pre-configured threshold ratio. The second module may also be further configured to determine whether a ratio of a number of the candidate resources remaining in the second plurality of candidate resources after the exclusion of the one or more resources from the second plurality of candidate resources to a number of the second plurality of candidate resources is less than 0.2 and increase the second threshold level relating to the RSRP in response to determining the ratio of the number of the candidate resources remaining in the second plurality of candidate resources to the number of the second plurality of candidate resources is less than 0.2. For example, the first module may be configured to set the second threshold level relating to the RSRP as the first threshold level relating to the RSRP, and decrease the first threshold level relating to the RSRP in response to determining the ratio of the number of the candidate resources remaining in the first plurality of candidate resources to the number of the first plurality of candidate resources is less than the pre-configured threshold ratio.

Additionally, the first module may be further configured to determine whether the second threshold level relating to the RSRP is lower than the first threshold level relating to the RSRP, and exclude the one or more resources from the first plurality of candidate resources and select the list of first resources from the candidate resources remaining in the first plurality of candidate resources in response to determining the second threshold level relating to the RSRP is lower than the first threshold level relating to the RSRP.

In another embodiment, the second module (comprised on the at least one controller 806 of the first UE or on a second/another UE) may be further configured to select the list of second resources from the second plurality of candidate resources and report the information relating to the list of second resources to a second higher layer (e.g., MAC layer) of the second module. The first module may be configured to select the list of first resources from the list of second resources based on the information retrieved from the second higher layer of the second module by the physical layer of the first module.

Yet in another embodiment, the first module may be further configured to select an initial list of first resources from the first plurality of candidate resources at the physical layer of the first module and report information relating to the initial list of first resources to a first higher layer (e.g., MAC layer) of the first module. The first module may be further configured to compare the initial list of first resources against the list of second resources based on the information relating to the list of second resources and the information relating to the initial list of first resources to determine one or more overlapping resources from the initial list of first resources and the list of second resources and select the list of first resources from the one or more overlapping resources.

Additionally, the first module may be further configured to determine a number of overlapping resources from the initial list of first resources and the list of second resources and select the list of first resources from the initial list of first resources in response to determining that there is less than one overlapping resource from the initial list of first resources and the list of second resources.

In another example, the communication apparatus 800 may be a second UE (different from the first UE above) and the at least one controller 806 of the circuitry 814 comprises a second module (not shown, e.g., NR SL module), which, in operation, is configured to select a list (or set) of second resources from second plurality of candidate resources. The circuitry 814 (or the at least one transmission signal generator 808 of the circuitry 814) may be configured to generate a signal comprising information relating to the list of second resources and the at least one radio transmitter 802 may then transmit the signal to another/first UE for use to select a list of first resources from a first plurality of candidate resources.

Yet in another example, the communication apparatus 800 may be a third UE (different from the first and/or second UE above) and the at least radio receiver 804, which, in operation, receives information relating to one or more resources from another/first UE, and the at least one controller 806 may comprises a module (not shown, e.g., NR SL module), which, in operation, is configured to select a list of third resources from a third plurality of candidate resources based on the information relating to the one or more resources. The circuitry 814 (or the at least one transmission signal generator 808 of the circuitry 814) of the third UE may be configured to generate a signal and the at least one radio transmitter 802 may then transmit the signal to another communication apparatus in one of the list of third resources. Alternatively or additionally, the at least one radio receiver 804 may receive a signal from another communication apparatus in one of the list of third resources and the circuitry 814 (or the at least one receive signal processor 810 of the circuitry 814) of the third UE may then process the signal.

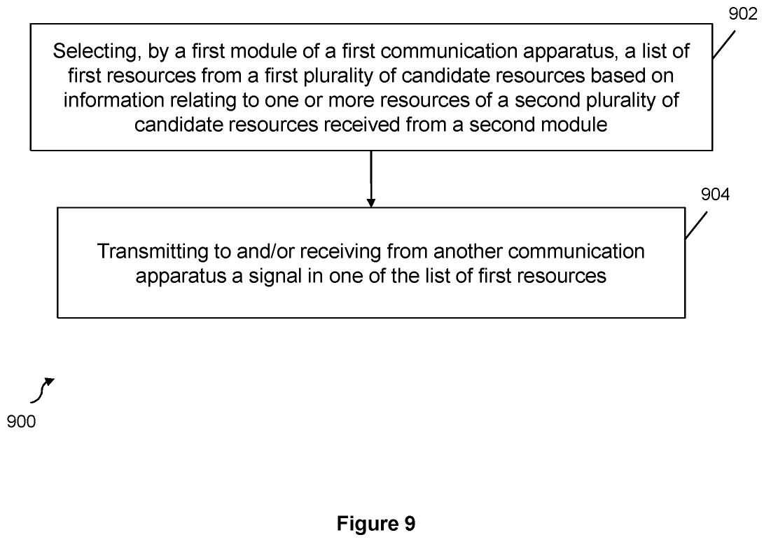

FIG. 9 shows a flowchart 900 illustrating a communication method implemented by a first communication apparatus (e.g., a first UE) according to various embodiments of the present disclosure. In step 902, a step of selecting, by a first module of the first communication apparatus, a list (or set) of first resources from a first plurality of candidate resources is carried out based on information relating to one or more resources of a second plurality of candidate resources received from a second module. In step 904, a step of transmitting to and/or receiving from another communication apparatus a signal is carried out in one of the list (or set) of first resources.

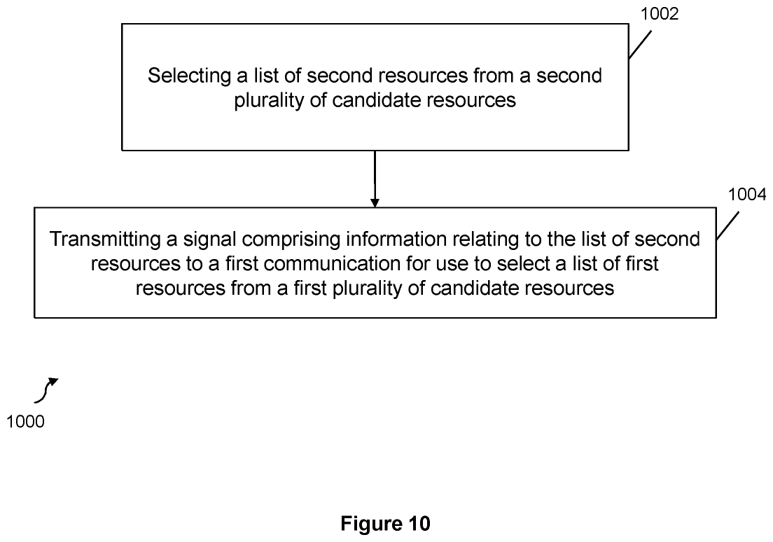

FIG. 10 shows a flowchart 1000 illustrating a communication method implemented by a second communication apparatus (e.g., a second UE) according to various embodiments of the present disclosure. In step 1002, a step of selecting a list (or set) of second resources from a second plurality of candidate resources is carried out. In step 1004, a step of transmitting a signal comprising information relating to the list (or set) of second resources to a first communication apparatus (e.g., a first UE) is carried out. The signal is for use by the first communication apparatus to select a list (or set) of first resources from a first plurality of candidate resources (e.g., step 902 in FIG. 9).

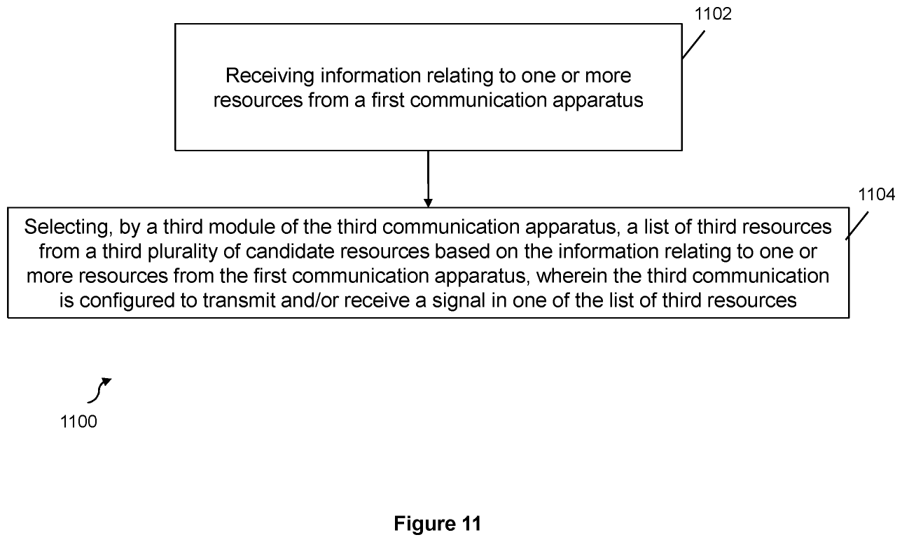

FIG. 11 shows a flowchart 1100 illustrating a communication method implemented by a third communication apparatus (e.g., a third UE) according to various embodiments of the present disclosure. In step 1102, a step of receiving information relating to one or more resources from a first communication apparatus is carried out. In step 1104, a step of selecting, by a third module of the third communication apparatus, a list (or set) of third resources from a third plurality of candidate resources is carried out based on the information relating to one or more resources from the first communication apparatus, wherein the third communication is configured to transmit and/or receive a signal in one of the list (or set) of third resources.

According to various embodiments of the present disclosure, the term “plurality of candidate resources” may refer to and be used interchangeably with the term “resource pool”. In other words, a NR resource pool refers to a (first) plurality of candidate resources from which a NR SL module will select a list or set of resources and use for receiving/transmitting a signal from/to another module (e.g., NR or LTE SL module) within the same or a different device, whereas an LTE resource pool refers to the same (first) or different (second) plurality of candidate resources from which an LTE SL module will select a list or set of resources and use for receiving/transmitting a signal from/to another module (e.g., LTE or NR SL module) within the same or a different device.

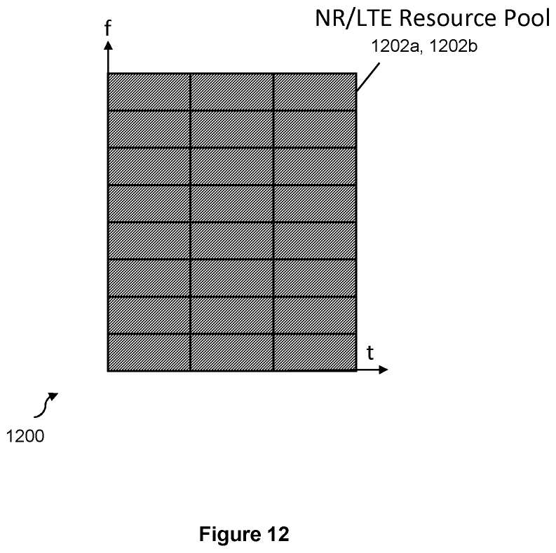

FIG. 12 depicts a block diagram 1200 illustrating a first exemplary mapping of a NR resource pool and an LTE resource pool according to the present disclosure. In this example, the NR resource pool of a UE corresponds and is identical to the LTE resource pool of the UE (or another UE) in terms of time and frequency. As a result, the resource selection (including resource exclusion) information relating to one or more resources of the LTE resource pool received/retrieved from the LTE SL module corresponds to the same one or more resources of the NR resource pool and can be used directly by the NR SL module to select a plurality of candidate resources or a list of resources from the NR resource pool for use to transmit/receive a signal to/from another UE.

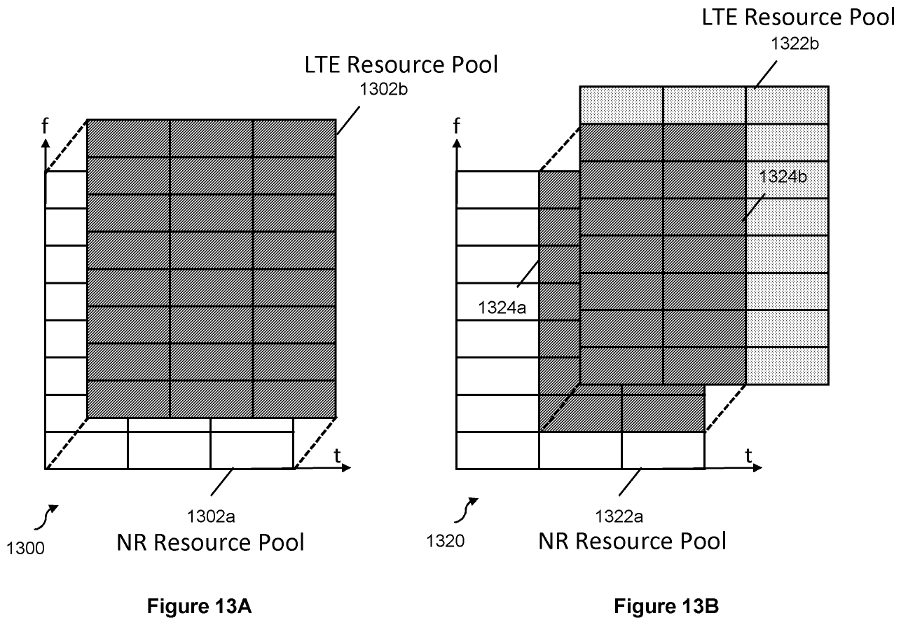

FIG. 13A depicts a block diagram 1300 illustrating a second exemplary mapping of a NR resource pool 1302a and an LTE resource pool 1302b according to the present disclosure. In this example, the NR resource pool 1302a of a UE and the LTE resource pool 1302b of the UE (or another UE) have separated (different) configurations in terms of time and frequency but the NR/LTE resource pools 1302a, 1302b are fully overlapped with each other. Each resource of the NR resource pool 1302a can be mapped to a resource of the LTE resource pool 13202b at different, offset time and frequency. As a result, the resource selection (including resource exclusion) information relating to one or more resources of the LTE resource pool 1302b received/retrieved from the LTE SL module can be translated and mapped to information relating to one or more resources of the NR resource pool 1302a. The information relating to the one or more resources of the NR resource pool 1302a mapped from the resource selection information received/retrieved from the LTE SL module can then be used by the NR SL module to select a plurality of candidate resources or a list of resources from the NR resource pool 1302a for use to transmit/receive a signal to/from another UE.

FIG. 13B depicts a block diagram 1320 illustrating a third exemplary mapping of a NR resource pool 1322a and an LTE resource pool 1322b according to present disclosure. In this example, the NR resource pool 1322a of a UE and the LTE resource pool 1322b of the UE (or another UE) have separated (different) configurations in terms of time and frequency but only a part 1324a, 1324b of the NR resource pool 1322a and the LTE resource pool 1322b is overlapped. Each resource of the overlapped part 1324a of the NR resource pool 1322a can be mapped to a resource of the overlapped part 1324b of the LTE resource pool 1322b at different, offset time and frequency. As a result, the resource selection (including resource exclusion) information relating to one or more resources of the overlapped part 1324b of the LTE resource pool 1322b receive/retrieved from the LTE SL module can be translated and mapped to information to relating to one or more resources of the overlapped part 1324a of the NR resource pool 1322a. The information relating to the one or more resources of the overlapped part 1324a of the NR resource pool 1322a mapped from the resource selection information received/retrieved from the LTE SL module can then be used by the NR SL module to select a plurality of candidate resources or a list of resources from the NR resource pool 1322a for use to transmit/receive a signal to/from another UE.

In the following paragraphs, a first embodiment of the present disclosure is explained with reference to a further exclusion of candidate resources based on a result of a determination between threshold levels relating to the RSRP of the NR and LTE SL modules.

According to the first embodiment, for a SL device that has both LTE SL module and NR SL module, the shared resource selection (e.g., sensing information) would be the result of each step for the LTE SL module as of section 14.1.1.6 of TS36.213, and the shared information is transparent to (i.e., can be retrieved by or shared by in-device signalling) to the NR SL module within the same device at physical layer.

The priority of LTE SL and NR SL are equivalent if with same sidelink control information (SCI) priority values. Other cases of priority relations can also be (pre-)configured. For example, an offset of “1” is set so that NR SL module treats LTE priority values as “LTE priority +1”. Also, only LTE priority in certain range (e.g., priority values between 1-3) will be treated in NR SL module.

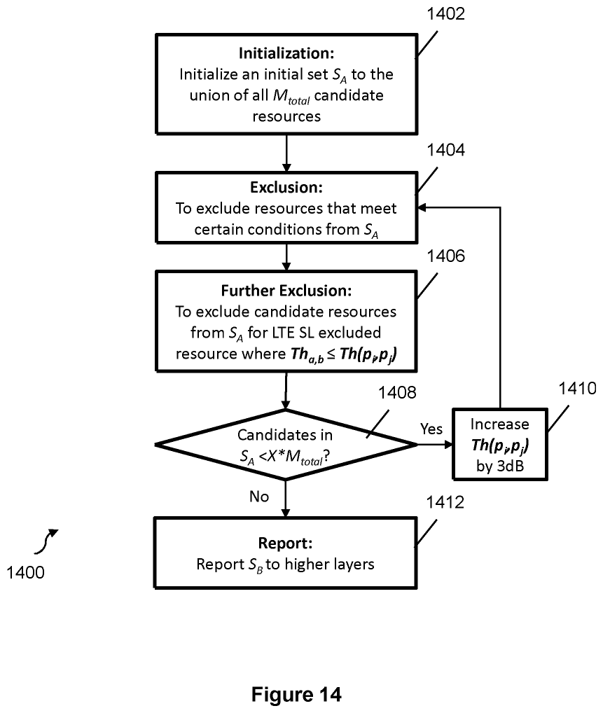

FIG. 14 shows a flowchart 1400 illustrating a resource selection process carried out by a NR SL module according to the first embodiment of the present disclosure. In step 1402, an initialization step is carried out where an initial set of candidate resources S_{A} (i.e., initial NR resource pool) is initialized to the union of all candidate resources Mₜₒₜₐₗ. In step 1404, an exclusion step is carried out where resources that meet certain conditions from the initial NR resource pool S_{A}. In one example, each of the candidate resources in the initial NR resource pool S_{A} has a level related to RSRP, and such level related to RSRP will be compared against a threshold level Th(pᵢ, pⱼ). The candidate resource will be excluded from the initial NR resource pool S_{A} if its level related RSRP is higher than the threshold level Th(pᵢ, pⱼ).

In step 1406, a further exclusion step if carried out where candidate resources that are excluded by LTE SL module (e.g., step 704 of FIG. 7) from the LTE resource pool would also be excluded by NR SL module from the initial NR resource pool. In one implementation, for resources that have been excluded by the LTE SL module from LTE resource pool at the threshold level Th_{a,b}, the NL SL module will also exclude those resources from the initial NR SL module at the threshold level Th(pᵢ, pᵢ) when the threshold level Th_{a,b} relating to the RSRP of the LTE SL module has a same or lower value than the threshold level Th(pᵢ, pⱼ) (i.e., Th_{a,b}≤Th(pᵢ, pⱼ)).

In step 1408, a step of determining if the number of candidate resources remaining in the NR resource pool S_{A} is smaller than X*Mₜₒₜₐₗ where X is a pre-configured threshold ratio of a number of candidate resources remaining in the NR resource pool S_{A} to total number of candidate resources between 0 to 1, is carried out. If the number of candidate resources remaining in the NR resource pool S_{A} is smaller than X*Mₜₒₜₐₗ, step 1410 is carried out; otherwise step 1412 is carried out. In step 1410, the threshold level Th(pᵢ, pⱼ) is increased by 3 dB such that the number of candidate resources remained in the set from the NR resource pool S_{A} may increase correspondingly.

The exclusion step, further exclusion step, determination step and the step with the threshold level Th(pᵢ, pⱼ) increased by 3 dB in steps 1404, 1406, 1408, 1410 are repeated in each iteration until it is determined that the number of candidate resources remaining in the NR resource pool S_{A} is no longer smaller than X*Mₜₒₜₐₗ. In step 1412, the resource candidate remaining in the NR resource pool S_{A} are moved to set of candidate resources S_{B} and the set S_{B} is reported to higher layers such as a MAC layer.

Additionally, if the LTE SL resource pool and NR SL resource pool are partially overlapped, when the candidate resources (the LTE reported 20% resources within the NR resource pool) is less than the X %, the following options are possible:
The NR SL module may use the less than X % candidate resources to report to MAC layer;
The NR SL module may increase threshold as per legacy procedure to reach X %;
If the overlapped part is a % in the LTE resource pool, to use LTE SL procedure to get 20% reported resource only from the overlapped a % part (or to only get a*20% from the overlapped a % part); or
If the overlapped part is b % in the NR resource pool, to use NR SL procedure to get X % is reported resource only from the overlapped b % part (or to only get b*X % from the overlapped b % part).

It is appreciated that the resource selection process described in FIG. 14 may be carried out alternatively by an LTE SL module, where in step 1406, candidate resources that are excluded by the NR SL module (e.g., step 604 of FIG. 6) would also be excluded by the LTE SL module from the LTE resource pool, and in step 1408, a step of determining if the number of candidate resources remaining in the LTE resource pool S_{A} is smaller than 0.2 Mₜₒₜₐₗ (i.e., the pre-configured threshold ratio of a number of candidate resources remaining in the LTE resource pool S_{A} to total number of candidate resources is 0.2) is carried out instead.

In the following paragraphs, a second embodiment of the present disclosure is explained with reference to a further exclusion of candidate resources by a SL module based on the set of resources reported by another SL module.

According to the second embodiment, for a SL device that has both LTE SL module and NR SL module, the shared resource selection (e.g., sensing information) would be the set of resources reported to MAC layer (S_{B}, 20% out of candidate resources (0.2 Mₜₒₜₐₗ) as of section 14.1.1.6 of TS36.213 in the LTE SL module, and the shared information is transparent to (i.e., can be retrieved by or shared by in-device signalling) to the NR SL module at physical layer.

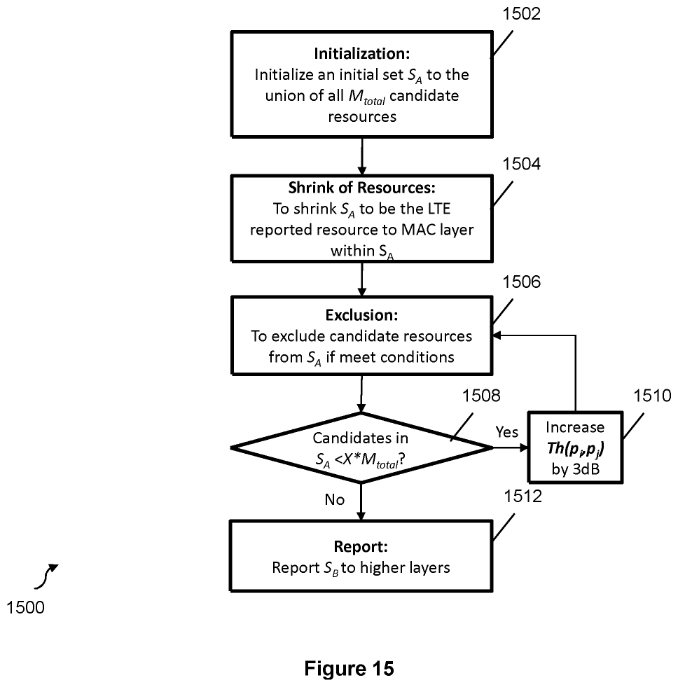

FIG. 15 shows a flowchart 1500 illustrating a resource selection process carried by a NR SL module according to the second embodiment of the present disclosure. In step 1502, an initialization step is carried out where an initial set of candidate resources S_{A} (i.e., initial NR resource pool) is initialized to the union of all candidate resources Mₜₒₜₐₗ. In step 1504, a resource shrinking step is carried out where the initial NR resource pool is shrunk and set to be the LTE resource set S_{B} reported to the MAC layer of the LTE SL module (e.g., step 714 of FIG. 7) within the initial NR resource pool S_{A}. In other words, the NR SL module would perform sensing procedure (i.e., resource selection at physical layer) within the LTE reported resources in the NR resource pool.

In step 1506, an exclusion step is carried out where resources that meet certain conditions from the shrunk NR resource pool S_{A}. In one example, each of the candidate resources in the shrunk NR resource pool S_{A} has a level related to RSRP, and such level related to RSRP will be compared against a threshold level Th(pᵢ, pⱼ). The candidate resource will be excluded from the shrunk NR resource pool S_{A} if its level related RSRP is higher than the threshold level Th(pᵢ, pⱼ).

In step 1508, a step of determination if the number of candidate resources remaining in the NR resource pool S_{A} is smaller than X*Mₜₒₜₐₗ is carried out, where X is a pre-configured threshold ratio of a number of candidate resources remaining in the NR resource pool SAto total number of candidate resources, and X is within the range of 0 and 1. For example, X is defined in TS38.214 as sl-TxPercentageList, and the value can be 0.2, 0.35, or 0.5 in Release 16 as per legacy procedures. If the number of candidate resources remaining in the NR resource pool S_{A} is smaller than X*Mₜₒₜₐₗ, step 1510 is carried out; otherwise step 1512 is carried out. In step 1510, the threshold level Th(pᵢ, pⱼ) is increased by 3 dB such that the number of candidate resources remained in the set from the NR resource pool S_{A} (and later S_{B} after the moving step in step 1512) may increase correspondingly.

Alternatively, a step of setting up the threshold level Th(pᵢ, pⱼ) to be the threshold level Th_{a,b} of the LTE SL module from which the shared information of the LTE reported resources is obtained and in each iteration of step 1510, the NR SL module may decrease the threshold level (from LTE threshold Th_{a,b}) to reach the X % (if X<20).

The exclusion step, determination step and the step with the threshold level Th(pᵢ, pⱼ) increased by 3 dB in steps 1506, 1508, 1510 are repeated in each iteration or until it is determined that the number of candidate resources remaining in the NR resource pool S_{A} is no longer smaller than X*Mₜₒₜₐₗ. In step 1512, the resource candidate remaining in the NR resource pool S_{A} are moved to set of candidate resources S_{B} and the set S_{B} is reported to higher layers such as a MAC layer. The exclusion step, determination step and the step with the threshold level Th(pᵢ, pᵢ) increased by 3 dB in steps 1506, 1508, 1510 may also be repeated in each iteration to achieve X % according to the value defined in TS38.214 as sl-TxPercentageList, to control the number of resources in S_{B}.

Additionally, if the LTE SL resource pool and NR SL resource pool are partially overlapped, when the candidate resources (the LTE reported 20% resources within the NR resource pool) is less than the X %, the following options are possible:
The NR SL module may use the less than X % candidate resources to report to MAC layer;
The NR SL module may increase threshold as per legacy procedure to reach X %;
If the overlapped part is a % in the LTE resource pool, to use LTE SL procedure to get 20% reported resource only from the overlapped a % part (or to only get a*20% from the overlapped a % part); or
If the overlapped part is b % in the NR resource pool, to use NR SL procedure to get X % is reported resource only from the overlapped b % part (or to only get b*X % from the overlapped b % part).

It is appreciated that the resource selection process described in FIG. 15 may be carried out alternatively by an LTE SL module, where in step 1504, the initial LTE resource pool is shrunk and set to be the NR resource set Sp reported to the MAC layer of the NR SL module (e.g., step 610 of FIG. 6) within the initial LTE resource pool S_{A}, and in step 1508, a step of determining if the number of candidate resources remaining in the LTE resource pool S_{A} is smaller than 0.2 Mₜₒₜₐₗ (i.e., the pre-configured threshold ratio of a number of candidate resources remaining in the LTE resource pool S_{A} to total number of candidate resources is 0.2) is carried out instead.

In the following paragraphs, a third embodiment of the present disclosure is explained with reference to a selection of resources in the intersection of NR reported resources and LTE reported resources at MAC layer.

According to the third embodiment, for a SL device that has both LTE SL module and NR SL module, the shared resource selection (e.g., sensing information) would be the set of resources reported to MAC layer (S_{B}, 20% out of candidate resources (0.2 Mₜₒₜₐₗ) as of section 14.1.1.6 of TS36.213 in the LTE SL module, and the shared information is transparent to (i.e., can be retrieved by or shared by in-device signalling) to the NR SL module at MAC layer.

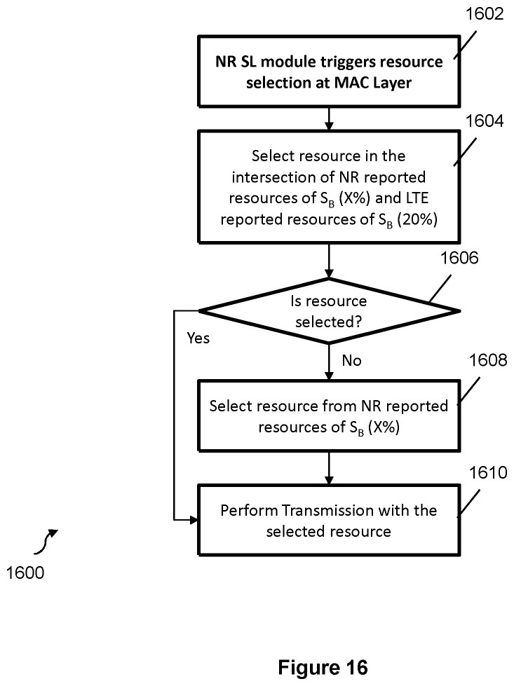

FIG. 16 shows a flowchart 1600 illustrating a resource selection process carried by a NR SL module at MAC layer according to the third embodiment of the present disclosure. In step 1602, a step of triggering a resource selection at MAC layer is carried out by a NR SL module, for example, after the SL module performs a sensing procedure as usual at physical layer (or without sensing procedure at physical layer). In step 1604, the NR SL module would select only a resource(s) in the intersection of (or overlapped between) resources set S_{B} (X % of Mₜₒₜₐₗ) reported by the NR SL module and resources set S_{B} (20% of Mₜₒₜₐₗ) reported by the LTE SL module to the MAC layer. In step 1606, a step of determining whether at least one resource selected, that is, if there is at least one overlapping resource between the NR reported resource set and the LTE reported resource set. If it is determined that there is no or less than one selected resource (overlapping resource), step 1608 is carried out, otherwise, if there is at least one resource is selected, step 1610 is carried out. In step 1608, the NR SL module will randomly select a resource(s) from the NR reported resources set S_{B} (X % of Mₜₒₜₐₗ) reported by the NR SL module itself. In step 1610, a step of selecting a resource from the selected overlapping resource(s) in step 1604 and performing a signal transmission with the selected resource from step 1608 or step 1604 is carried out.

Alternatively, the SL device may skip physical layer sensing and in step 1602, the NR SL module triggers resource selection at MAC layer, for example, when other devices report a preferred LTE resources set. In step 1604, the NR SL module would select only a resource(s) in the intersection of (or overlapped between) NR resource pool Mₜₒₜₐₗ and preferred LTE resources set S_{B} (20% of Mₜₒₜₐₗ) indicated by the other devices. In step 1606, a step of determining whether at least one resource selected, that is, if there is at least one overlapping resource between the NR resource pool and the indicated preferred LTE resources set.

In the following paragraphs, a fourth embodiment of the present disclosure is explained with reference to a selection of resources in the intersection of NR reported resources and LTE reported resources at MAC layer.

According to the fourth embodiment, for a SL device that has both LTE SL module and NR SL module, the shared resource selection (e.g., sensing information) would be the set of resources reported to MAC layer (S_{B}, 20% out of candidate resources (0.2 Mₜₒₜₐₗ) as of section 14.1.1.6 of TS36.213 in the LTE SL module, and the shared information is transparent to (i.e., can be retrieved by or shared by in-device signalling) to the NR SL module at physical (PHY) or higher layers (e.g., MAC layer). Then, for NR SL module within the NR SL module of this SL device, over-the-air signalling (e.g., inter-UE coordination or IUC) could be used to indicate that the set of 20% resource of the LTE reported resources is to be considered as a preferred resources set. The over-the-air signalling can be transmitted through unicast, groupcast or broadcast to the NR SL module.

In this embodiment, other SL devices (with both LTE and NR SL modules, or with only NR SL modules) may receive the over-the-air signal comprising the LTE reported resources transmitted by the LTE SL module of the SL device, and perform resource selection at their respective MAC layers.

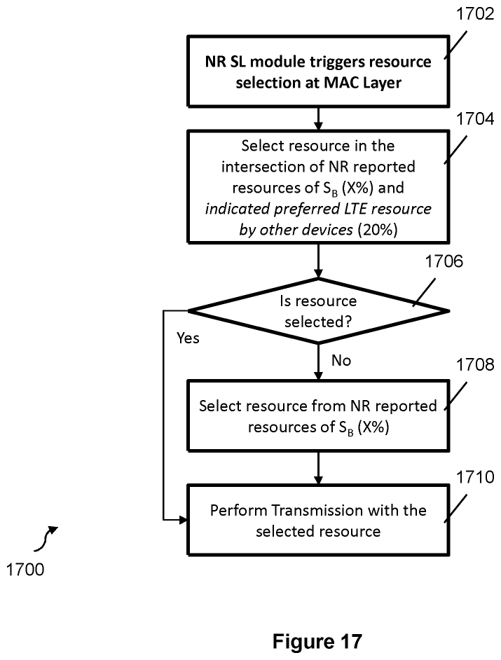

FIG. 17 shows a flowchart 1700 illustrating a resource selection process carried by a NR SL module of a SL device at MAC layer after receiving preferred LTE reported resources indicated by other SL devices according to a first example of the fourth embodiment of the present disclosure. In step 1702, a step of triggering a resource selection at MAC layer is carried out by the NR SL module, for example, after the SL module of the SL device performs a sensing procedure as usual at physical layer (or without sensing procedure at physical layer) and other devices report a preferred LTE resources set. In step 1704, the NR SL module would select only a resource(s) in the intersection of (or overlapped between) resources set S_{B} (X % of Mₜₒₜₐₗ) reported by the NR SL module and preferred LTE resources set S_{B} (20% of Mₜₒₜₐₗ) indicated by the other devices. In step 1706, a step of determining whether at least one resource selected, that is, if there is at least one overlapping resource between the NR reported resource set and the indicated preferred LTE resources set. If it is determined that there is no or less than one selected resource (overlapping resource), step 1708 is carried out, otherwise, if there is at least one resource is selected, step 1710 is carried out. In step 1708, the NR SL module will randomly select a resource(s) from the NR reported resources set S_{B} (X % of Mₜₒₜₐₗ) reported by the NR SL module itself. In step 1710, a step of selecting a resource from the selected overlapping resource(s) in step 1704 and performing a signal transmission with the selected resource from step 1708 or step 1704 is carried out.

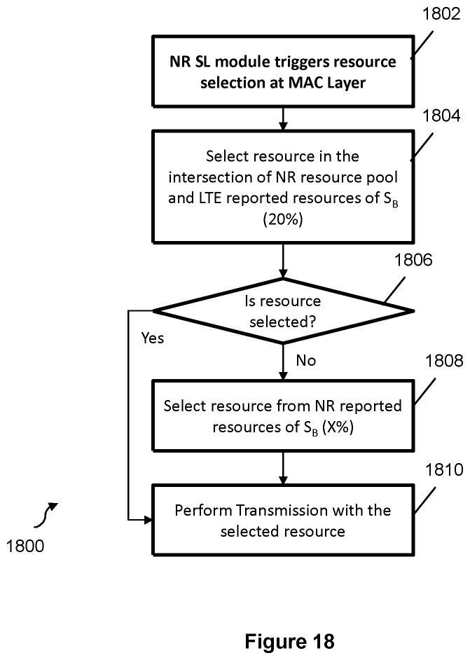

FIG. 18 shows a flowchart 1800 illustrating a resource selection process carried by a NR SL module of a SL device at MAC layer after receiving preferred LTE reported resources indicated by other SL devices according to a second example of the fourth embodiment of the present disclosure. In this example, the SL device skips physical layer sensing and in step 1802, the NR SL module triggers resource selection at MAC layer, for example, when other devices report a preferred LTE resources set. In step 1804, the NR SL module would select only a resource(s) in the intersection of (or overlapped between) NR resource pool Mtotal and preferred LTE resources set S_{B} (20% of Mₜₒₜₐₗ) indicated by the other devices. In step 1806, a step of determining whether at least one resource selected, that is, if there is at least one overlapping resource between the NR resource pool and the indicated preferred LTE resources set. If it is determined that there is no or less than one selected resource (overlapping resource), step 1808 is carried out, otherwise, if there is at least one resource is selected, step 1810 is carried out. In step 1808, the NR SL module will randomly select a resource(s) from the NR reported resource of S_{B} reported by the NR SL module itself. In step 1810, a step of selecting a resource from the overlapping resource(s) in step 1804 and performing a signal transmission with the selected resource from step 1808 or step 1804 is carried out.

Additionally, over-the-air signaling can also be used to indicate NR SL module's shared sensing information to other SL devices in addition to LTE SL module's shared sensing information

It is noted that, in any of the various embodiments described above, the LTE resource selection at physical layer and MAC layer (i.e., sensing and resource reservation procedure) carried out by a LTE SL module may be carried out prior to, parallel with or after the NR resource selection at physical layer and MAC layer (i.e., sensing and resource reservation procedure) carried out by a NR SL module. Similarly, the shared resource selection for one SL module (e.g., NR SL module) can be obtained and retrieved from another SL module (e.g., LTE SL module) prior to, during, or after the LTE resource sensing and reservation procedures carried out by the SL module (e.g., NR SL module).

In various embodiments above, a SL module (e.g., NR SL module) of a device may use in-device signalling or over-the-air signalling (e.g., SL, uplink or downlink transmission) to trigger sensing and resource reservation procedure in another SL module of the same or a different device. The in-device signalling to indicate the shared resource selection information can be up to implementation. Additionally or alternatively, the feature(s) of shared resource selection, utilizing shared resource selection information, in-device or over-the-air signalling for sharing the resource selection information in a SL module can be enabled or disabled, either jointly or separately.

In various embodiments above, for SL devices in eNB/gNB coverage (in LTE mode 3 or 4, NR mode 1 or 2), they can use eNB/gNB to relay the shared resource selection information via uplink and downlink to other sidelink devices. For any of the embodiments described above, the NR and LTE can be replaced by LTE and NR respectively. The method that LTE shared resource selection information to be utilized by NR SL module for NR SL, can also be applied in the way that NR shared resource selection information to be utilized by LTE SL module for LTE SL.

In the following paragraphs, certain exemplifying embodiments are explained with reference to terms related to 5G core network and the present disclosure regarding communication apparatuses and methods for allocating one or more additional operating windows between two semi-statically configured SL DRX cycles for a reception or a transmission of a SL signal, namely:

### Control Signals

In the present disclosure, the downlink control signal (information) related to the present disclosure may be a signal (information) transmitted through PDCCH of the physical layer or may be a signal (information) transmitted through a MAC Control Element (CE) of the higher layer or the RRC. The downlink control signal may be a pre-defined signal (information).

The uplink control signal (information) related to the present disclosure may be a signal (information) transmitted through PUCCH of the physical layer or may be a signal (information) transmitted through a MAC CE of the higher layer or the RRC. Further, the uplink control signal may be a pre-defined signal (information). The uplink control signal may be replaced with uplink control information (UCI), the 1st stage sidelink control information (SCI) or the 2nd stage SCI.

### Base Station

In the present disclosure, the base station may be a Transmission Reception Point (TRP), a clusterhead, an access point, a Remote Radio Head (RRH), an eNodeB (eNB), a gNodeB (gNB), a Base Station (BS), a Base Transceiver Station (BTS), a base unit or a gateway, for example. Further, in sidelink communication, a terminal may be adopted instead of a base station. The base station may be a relay apparatus that relays communication between a higher node and a terminal. The base station may be a roadside unit as well.

### Uplink/Downlink/Sidelink

The present disclosure may be applied to any of uplink, downlink and sidelink.

The present disclosure may be applied to, for example, uplink channels, such as PUSCH, PUCCH, and PRACH, downlink channels, such as PDSCH, PDCCH, and PBCH, and side link channels, such as Physical Sidelink Shared Channel (PSSCH), Physical Sidelink Control Channel (PSCCH), and Physical Sidelink Broadcast Channel (PSBCH).

PDCCH, PDSCH, PUSCH, and PUCCH are examples of a downlink control channel, a downlink data channel, an uplink data channel, and an uplink control channel, respectively. PSCCH and PSSCH are examples of a sidelink control channel and a sidelink data channel, respectively. PBCH and PSBCH are examples of broadcast channels, respectively, and PRACH is an example of a random access channel.

### Data Channels/Control Channels

The present disclosure may be applied to any of data channels and control channels. The channels in the present disclosure may be replaced with data channels including PDSCH, PUSCH and PSSCH and/or control channels including PDCCH, PUCCH, PBCH, PSCCH, and PSBCH.

### Reference Signals

In the present disclosure, the reference signals are signals known to both a base station and a mobile station and each reference signal may be referred to as a Reference Signal (RS) or sometimes a pilot signal. The reference signal may be any of a DMRS, a Channel State Information-Reference Signal (CSI-RS), a Tracking Reference Signal (TRS), a Phase Tracking Reference Signal (PTRS), a Cell-specific Reference Signal (CRS), and a Sounding Reference Signal (SRS).

### Time Intervals

In the present disclosure, time resource units are not limited to one or a combination of slots and symbols, and may be time resource units, such as frames, superframes, subframes, slots, time slot subslots, minislots, or time resource units, such as symbols, Orthogonal Frequency Division Multiplexing (OFDM) symbols, Single Carrier-Frequency Division Multiplexing Access (SC-FDMA) symbols, or other time resource units. The number of symbols included in one slot is not limited to any number of symbols exemplified in the embodiment(s) described above, and may be other numbers of symbols.

### Frequency Bands

The present disclosure may be applied to any of a licensed band and an unlicensed band.

### Communication

The present disclosure may be applied to any of communication between a base station and a terminal (Uu-link communication), communication between a terminal and a terminal (Sidelink communication), and Vehicle to Everything (V2X) communication. The channels in the present disclosure may be replaced with PSCCH, PSSCH, Physical Sidelink Feedback Channel (PSFCH), PSBCH, PDCCH, PUCCH, PDSCH, PUSCH, and PBCH.

In addition, the present disclosure may be applied to any of a terrestrial network or a network other than a terrestrial network (NTN: Non-Terrestrial Network) using a satellite or a High Altitude Pseudo Satellite (HAPS). In addition, the present disclosure may be applied to a network having a large cell size, and a terrestrial network with a large delay compared with a symbol length or a slot length, such as an ultra-wideband transmission network.

### Antenna Ports

An antenna port refers to a logical antenna (antenna group) formed of one or more physical antenna(s). That is, the antenna port does not necessarily refer to one physical antenna and sometimes refers to an array antenna formed of multiple antennas or the like. For example, it is not defined how many physical antennas form the antenna port, and instead, the antenna port is defined as the minimum unit through which a terminal is allowed to transmit a reference signal. The antenna port may also be defined as the minimum unit for multiplication of a precoding vector weighting.

The present disclosure can be realized by software, hardware, or software in cooperation with hardware. Each functional block used in the description of each embodiment described above can be partly or entirely realized by an LSI such as an integrated circuit, and each process described in the each embodiment may be controlled partly or entirely by the same LSI or a combination of LSIs. The LSI may be individually formed as chips, or one chip may be formed so as to include a part or all of the functional blocks. The LSI may include a data input and output coupled thereto. The LSI here may be referred to as an IC, a system LSI, a super LSI, or an ultra LSI depending on a difference in the degree of integration. However, the technique of implementing an integrated circuit is not limited to the LSI and may be realized by using a dedicated circuit, a general-purpose processor, or a special-purpose processor. In addition, a FPGA (Field Programmable Gate Array) that can be programmed after the manufacture of the LSI or a reconfigurable processor in which the connections and the settings of circuit cells disposed inside the LSI can be reconfigured may be used. The present disclosure can be realized as digital processing or analogue processing. If future integrated circuit technology replaces LSIs as a result of the advancement of semiconductor technology or other derivative technology, the functional blocks could be integrated using the future integrated circuit technology. Biotechnology can also be applied.

The present disclosure can be realized by any kind of apparatus, device or system having a function of communication, which is referred to as a communication apparatus.

The communication apparatus may comprise a transceiver and processing/control circuitry. The transceiver may comprise and/or function as a receiver and a transmitter. The transceiver, as the transmitter and receiver, may include an RF (radio frequency) module including amplifiers, RF modulators/demodulators and the like, and one or more antennas.

Some non-limiting examples of such a communication apparatus include a phone (e.g, cellular (cell) phone, smart phone), a tablet, a personal computer (PC) (e.g, laptop, desktop, netbook), a camera (e.g., digital still/video camera), a digital player (digital audio/video player), a wearable device (e.g., wearable camera, smart watch, tracking device), a game console, a digital book reader, a telehealth/telemedicine (remote health and medicine) device, and a vehicle providing communication functionality (e.g., automotive, airplane, ship), and various combinations thereof.

The communication apparatus is not limited to be portable or movable, and may also include any kind of apparatus, device or system being non-portable or stationary, such as a smart home device (e.g., an appliance, lighting, smart meter, control panel), a vending machine, and any other “things” in a network of an “Internet of Things (IoT)”.

The communication may include exchanging data through, for example, a cellular system, a wireless LAN system, a satellite system, etc., and various combinations thereof.

The communication apparatus may comprise a device such as a controller or a sensor which is coupled to a communication device performing a function of communication described in the present disclosure. For example, the communication apparatus may comprise a controller or a sensor that generates control signals or data signals which are used by a communication device performing a communication function of the communication apparatus.

The communication apparatus also may include an infrastructure facility, such as a base station, an access point, and any other apparatus, device or system that communicates with or controls apparatuses such as those in the above non-limiting examples.

It will be appreciated by a person skilled in the art that numerous variations and/or modifications may be made to the present disclosure as shown in the specific embodiments without departing from the spirit or scope of the disclosure as broadly described. The present embodiments are, therefore, to be considered in all respects illustrative and not restrictive.

1.-17. (canceled)

18. A first communication apparatus, comprising:
circuitry, which, in operation, determines a first plurality of resources used for new radio (NR) sidelink communication based on information relating to a long-term evolution (LTE) sidelink communication; and
a transceiver, which, in operation, reports the first plurality of resources to higher layer(s).

19. The first communication apparatus of claim 18, wherein the first plurality of resources are determined from a first plurality of candidate resources by excluding one or more resources based on the information.

20. The first communication apparatus of claim 19, wherein the first plurality of candidate resources overlap with a second plurality of candidate resources used for the LTE sidelink communication.

21. The first communication apparatus of claim 18, wherein the information is transmitted from another communication apparatus.

22. The first communication apparatus of claim 18, wherein the information is a threshold relating to a reference signal received power (RSRP), which is used for excluding one or more resources.

23. The first communication apparatus of claim 18, wherein the information is a threshold relating to a reference signal received power (RSRP), wherein a priority relating to the RSRP of the LTE sidelink communication is different from a priority relating to the RSRP of the NR sidelink communication.

24. A communication method performed by a first communication apparatus, comprising:
determining a first plurality of resources used for new radio (NR) sidelink communication based on information relating to a long-term evolution (LTE) sidelink communication; and
reporting the first plurality of resources to higher layer(s).

25. The communication method of claim 24, wherein the first plurality of resources are determined from a first plurality of candidate resources by excluding one or more resources based on the information.

26. The communication method of claim 25, wherein the first plurality of candidate resources overlap with a second plurality of candidate resources used for the LTE sidelink communication.

27. The communication method of claim 24, wherein the information is transmitted from another communication apparatus.

28. The communication method of claim 24, wherein the information is a threshold relating to a reference signal received power (RSRP), which is used for excluding one or more resources.

29. The communication method of claim 24, wherein the information is a threshold relating to a reference signal received power (RSRP), wherein a priority relating to the RSRP of the LTE sidelink communication is different from a priority relating to the RSRP of the NR sidelink communication.

30. An integrated circuit, comprising:
determination circuitry, which in operation, controls a determination of a first plurality of resources used for new radio (NR) sidelink communication based on information relating to a long-term evolution (LTE) sidelink communication; and
report circuitry, which in operation, controls a report of the first plurality of resources to higher layer(s).
